(19) United States
(12) Patent Application Publication
(10) Pub. No.: US 2003/0014239 A1
(43) Pub. Date: Jan. 16, 2003

(54) Method and system for entering accented and other extended characters

(76) Inventors: Jean D. Ichbiah, Essex, MA (US); Jacques Turbe, Paris (FR); Emmanuel Ichbiah, Versailles (FR)

Correspondence Address: IANDIORIO & TESKA, INTELLECTUAL PROPERTY LAW ATTORNEYS, 260 BEAR HILL ROAD, WALTHAM, MA, 02451-1018, US

(21) Appl. No.: 09/877,284

(22) Filed: Jun. 8, 2001

(51) Int. Cl. G06F 17/28

(52) U.S. Cl. 704/7

(57) ABSTRACT

A method of and system for entering extended characters. The method includes detecting, on a touch screen, a touch on a character and a slide away from the character; determining the direction of the slide; matching the direction of the slide with a stored set of extended characters each associated with a corresponding different slide direction; and displaying the extended character which corresponds to the determined slide direction.

### FIELD OF THE INVENTION

This invention relates to a method and system for entering accented and other extended characters on hand-held electronic devices having touch-screens, e.g., Palm Pilot type electronic computers.

### BACKGROUND OF THE INVENTION

So As computers become smaller, so too do their associated input devices to the point where, for hand-held electronic devices such as the Palm Pilot and the Pocket PC, there is no physical keyboard.1

Instead, the touch-screen displays a representation of a small QWERTY keyboard that includes the usual set of around one hundred basic ANSI characters, and the user uses a touch-pen to enter these basic characters. The first inventor of the subject application invented a more efficient keyboard for such devices. See U.S. Pat. No. 5,487,616 incorporated herein by this reference. See also U.S. Pat. No. 5,623,406 incorporated herein by this reference.

Still, it can be difficult and time consuming to enter characters that are not in the basic ANSI character set. For example, to enter the accented character ä, a modification key must be selected, a pull-down menu or an alternate letter panel activated, and the accented character then entered.

The windows CE standard keyboard made it somewhat easier to enter basic characters that are capital letters. The user touches the letter to be capitalized and slides the pen up and computer software operating on the hand-held electronic device then interprets this action to indicate that the capital version of the touched letter is to be entered and displayed. If the pen slide is to the left, a backspace is entered and if the pen slide is to the right, a space is entered.

The Windows CE technique, however, does not provide for the entry of characters not present on the QWERTY keyboard, such as accented characters (e.g., ä, à, á), and other extended characters (e.g., \dot{a}, β, ®, §, ∫, Π, Δ, Σ, α, □, [symbol] , [symbol] , [symbol] , [symbol] , [symbol] , and [symbol] ).

Moreover, the Windows CE technique does not provide for customization wherein the user can define which characters are to be entered based on slides in different directions.

### SUMMARY OF THE INVENTION

It is therefore an object of this invention to provide a method of more easily entering accented and other extended characters.

It is a further object of this invention to provide such a method which is easier and less time consuming than prior art methods wherein an alternate panel or a pull-down menu must be activated.

It is a further object of this invention to provide such a method which is much more versatile than the prior art Windows CE method of entering capital letters.

It is a further object of this invention to provide a more ergonomic, user-friendly, and universal method of and system for entering extended characters.

It is a further object of this invention to provide such a method and system which allows the user to customize a hand-held electronic device to more quickly enter a wide variety of characters, by touching a character, icon, or even a button and then slide the touch pen to more quickly have the electronic device perform an action represented by the corresponding entry.

The invention results from the realization that a more ergonomic, user-friendly, more universal, and customizable system and method for quickly entering and displaying on a touch-screen a wide variety of characters includes associating different pen-slide directions for different displayed keyboard characters with a wide variety of extended characters not necessarily present on the keyboard. The default extended characters are accented characters with a circumflex accent for a slide directly right, with an acute accent for a slide up and to the right, with an umlaut for a slide directly up, with a grave accent for a slide up and to the left, and with a dot-ring for a slide directly left.

The individual user can then replace these default settings with a wide variety of extended characters not found on the keyboard. For example, a touch on the letter E and a left slide could cause the entry and display of the CΕ character; a touch on the letter s and a slide to the right could cause the entry and display of “sch”; a touch on the letter R and a slide down to the left could cause the entry and display of the ® character; and a touch on the letter S and a slide downward would cause the entry and display of the § character.

In this way, eight extended characters per keyboard character can be easily and quickly displayed and entered depending on the user's preferences, nationality, and typical usage. Indeed, the user can assign entries to slides away from different keyboard characters, icons, or buttons in different directions to cause numerous actions to occur: the display and entry of various extended characters, the entry of a web-page address, a change from one application program to another, or the display of a schedule or calculator (when, for example, the letter C is touched and a slide is made downward), and the like.

Finally, it is even possible to have sixteen (or more) extended characters per keyboard characters by detecting slides of different length, and by assigning different actions based on the direction and on two (or more) different lengths. Having two different lengths is quite natural and this offers a way to enter a wide variety of characters easily and quickly.

There is an inherent difficulty in allowing a keyboard to represent a large number of characters. Typically, an on-screen keyboard includes around 40 to 50 different keys that are used for letters and modifiers. Several reasons limit this number. First is the size of the device itself, which is usually small. Adding keys is not usually possible by making them smaller since it would then be difficult to tap on a key without making errors.

One solution to increase the number of characters is by means of modifier keys. One example is the Shift key; other examples include modifier keys for accented characters and other symbols. When a modifier key is pressed on an on-screen keyboard, an alternative letter panel may be displayed and users can tap on these alternative letters.

A major drawback of modifier keys and alternative panels is that they are slow to use. To get a letter on an alternative panel requires a tap on the modifier key followed by a second tap on the key itself. Furthermore, modifier keys tend to be located on the periphery of the on-screen keyboard and this means that the two taps require travel between distant keys, something that is inherently slow because it involves moving the hand and not just the finger holding the stylus.

Sliding as defined in this invention offers a better solution. By associating alternative extended characters to sliding directions, the number of characters that can be entered on the on-screen keyboard can be multiplied by eight and even by a factor of sixteen if different letters are used for short and long slides (for example, using short slides for lower case extended characters and long slides for upper case.) Applying this to a basic matrix of 40 characters means that more than 600 different characters can be generated and thereby basically cover all characters of the Pan-European set of the Windows Glyph List 4.

In addition, the action of sliding is a very fast one that is only marginally slower than a single tap on a key. The sliding move is always to an adjacent key and never involves moving the hand itself.

This invention features a method of entering extended characters, the method comprising: detecting, on a touch screen, a touch on a character and a slide away from the character; determining the direction of the slide; and matching the direction of the slide with a stored set of extended characters each associated with a corresponding different slide direction.

The method may further include initially entering the touched character and then replacing the entered character with the corresponding extended character after the slide. Typically, the touched character is changed to the extended character on the keyboard representative on the touch screen.

The stored default set of extended characters may include accented characters and, for each character, the character marked with a grave, a dot, the umlaut, the acute, and the circumflex, each accent corresponding to a slide in a different direction. The method may further include determining the length of the slide. Then, a stored set of extended characters corresponds to the slides of a short length and a stored set of other characters (e.g. upper case characters) correspond to slides of a longer length. The method may also include the steps of displaying the stored set of extended characters and their corresponding slide directions and allowing the user to replace an extended character with a different character, a sequence of characters, or an action. Typically, there are from five to eight slide directions, each slide direction corresponding to a different extended character.

The computer program for entering extended characters of this invention includes a stored set of extended characters each corresponding to a different slide direction; an input routine which determines which character was touched and the direction of a slide away from the touched character; a lookup routine which matches the touched character and the direction of the slide with the corresponding stored extended character; and an output routine which enters and causes the display of the corresponding stored extended character.

The output routine may initially enter the touched character and then replace the touched character with the extended character after the slide both on the keyboard representation and on the touchscreen text portion. The stored set of default extended characters may include accented characters and, for each character, the character marked with the grave, the dot, the umlaut, the acute, and the circumflex, each said accent corresponding to a slide in a different direction.

The input routine is typically further configured to determine the length of the slide. Then, the stored set of extended characters corresponds to slides of a first length and there is a stored set of other characters (e.g., upper case extended characters) corresponding to slides of a second, different length. The customization routine of this invention displays the stored set of extended characters and their corresponding set of slide directions and allows the user to replace a stored extended character with a different character, a sequence of characters, or an action. Typically, there are from five to eight slide directions, each slide direction corresponding to a different extended character.

The method of customizing input for an electronic device with a touch screen of this invention may include displaying, on a touch screen, a set of slide directions and allowing the user to assign an entry to a slide direction representing an action for a plurality of characters, icons, or buttons; storing each entry with its corresponding slide direction and the assigned character, icon, or button; detecting, on the touch screen, a touch at a location representing a character, icon, or button and a slide away from the touched location; determining the direction of the slide; matching the location and the direction of the slide with the corresponding entry; and performing the action represented by the corresponding entry.

The system for customizing input for an electronic device with a touch screen of this invention may include a customization routine which displays to a user a set of slide directions and allows the user to assign entries representing actions to a slide direction for a plurality of characters, icons, or buttons; an input routine which determines a touch location on the touch screen representing a character, icon, or button and the direction of a slide away from the touch location; a lookup routine which matches the touch location and the direction of the slide with the corresponding assigned entry; and an output routine which performs the action represented by the corresponding entry.

### BRIEF DESCRIPTION OF THE DRAWINGS

Other objects, features and advantages will occur to those skilled in the art from the following description of a preferred embodiment and the accompanying drawings, in which:

FIG. 1 is a front schematic view of a typical hand-held electronic computer such as the Palm Pilot device;

FIG. 2 is a view depicting how the user touches a character displayed on the “keyboard” of the electronic device and slides the pen away from the character in accordance with this invention;

FIG. 3 shows a typical stored set of default accented characters each associated with a corresponding different slide direction in accordance with the subject invention;

FIG. 4 is a view of a customizable menu in accordance with the subject invention showing the case where a user enables one default setting;

FIG. 5 is a view similar to FIG. 4 except now the user has enabled five default settings;

FIG. 6 is a view of a menu selection screen wherein the user is allowed to confirm the current effect of a specific slide direction for a given key;

FIG. 7 is a view similar to FIG. 6 except a different key has been entered;

FIGS. 8-12 are views showing how the user operates the customization routine of the subject invention to replace a default character with a different character, a sequence of characters, or an action for different slide directions and different characters;

FIG. 13 is a block diagram showing the primary components associated with the computer program of the subject invention;

FIG. 14 is a flowchart depicting the primary steps associated with the operation of the computer program of this invention;

FIG. 15 is a flowchart depicting the primary steps associated with the customization subroutine of the subject invention; and

FIG. 16 is a flowchart depicting the primary steps associated with the input subroutine of the subject invention.

### DISCLOSURE OF THE PREFERRED EMBODIMENT

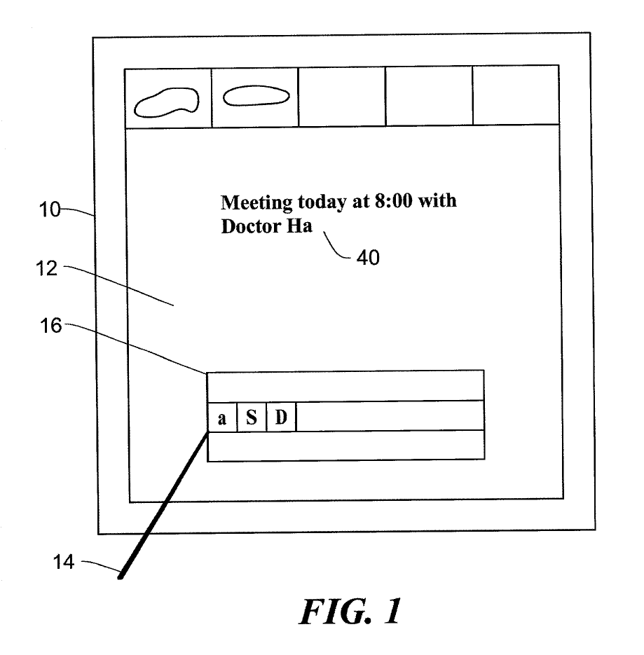

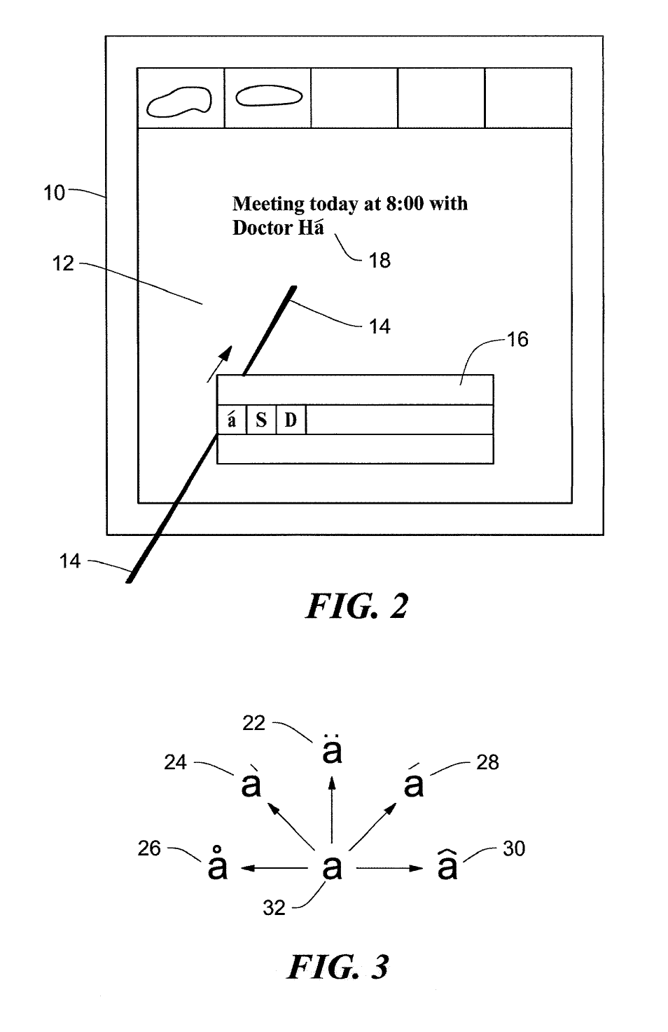

In accordance with this invention, Palm Pilot or Pocket PC hand held computer FIG. 1 and other hand-held electronic devices have touch-screen or pad 12 and pen 14 used to select the characters of “keyboard” 16. A touch or a tap on a character as shown in FIG. 1 and a slide away from the character as shown in FIG. 2 is detected by the programming of this invention. In FIG. 2, the direction of the slide is determined to be northeast. The computer program of this invention then matches the direction of the slide with a stored set of extended characters each associated with a corresponding different slide direction. In the preferred embodiment, the default stored set of extended characters are a subset of the accented characters as shown in FIG. 3: the grave 24, the umlaut 22, the acute 28, and the circumflex 30 each corresponding to a different slide direction. When the computer program detects a touch on the letter “a” and a slide up and to the right (northeast), the “á” accented character is entered and displayed in place of the “a” on keyboard 16 as shown and then, when pen 14 is lifted, the “á” character is entered and displayed on touch-screen 12 as shown at 18.

Initially, the tapped or touched character “a” is entered and displayed as shown in FIG. 1 at 40. After the slide, however, the touch character “a” is replaced with the corresponding accented character “á” as shown in FIG. 2.

The method of this invention thus complies with good ergonomic practices since it provides the user with a visual indication of each user action. Changing the touched character on keyboard 16, FIG. 2 to the appropriate extended character to be entered is also a good ergonomic practice.

“Extended characters” as used herein include the default accented characters such as, for each character, the character mark with a grave 24, FIG. 3, the umlaut 22, the acute 28, and the circumflex 30, each accent corresponding to a slide in a different direction for each character as shown in FIG. 3. This invention, however, is not limited to accented characters. For example, as shown in FIG. 3, a slide to the left denotes the entry of the extended character “\dot{a}”, 26.

Indeed, the set of possible extended characters include characters of the ANSI/ISO character set whose codes are in the range 128-255 (the Latin-1 Supplement, Letter-Like symbols, General Punctuation, Spacing Modifier Letters, Latin Extended-A, and Latin Extended-B); the more general UNICODE international character set; and the UNICODE subset known as the Microsoft Windows Glyph list 4. These numerous possible characters go far beyond the characters that are present on a typical keyboard (typically limited to the Basic Latin character subset of the ANSI/ISO character set, whose codes are in the range 32-127).

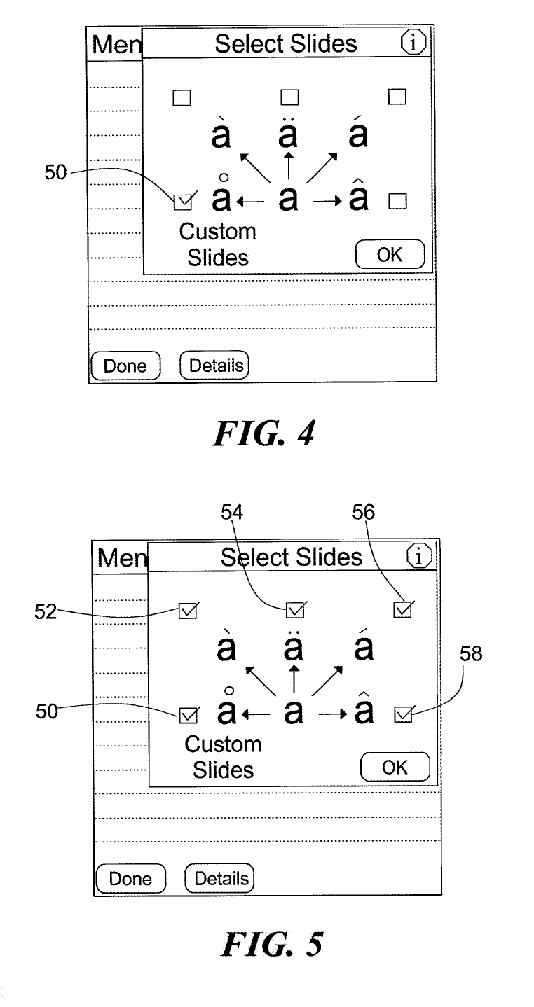

As shown in FIG. 4, the stored set of default accented characters are displayed to the user along with their corresponding slide directions. In this invention, however, the user is conveniently allowed to replace any accented character with a different character, a sequence of characters, or even an action. By checking box 50, FIG. 4, the user enables only the default dot extended character when a touch-pen touches the “a” character and is slid to the left. In FIG. 5, by checking boxes 50, 52, 54, 56, and 58, all the default characters are enabled. Typically, there are at least 5 slide directions, each slide direction corresponding to a different accented or other extended character as shown in FIGS. 3-5. If slides in the downward directions are easy, as on a Pocket PC, the full eight slide directions can be used: North, Northeast, East, Southeast, South, Southwest, West, and Northwest.

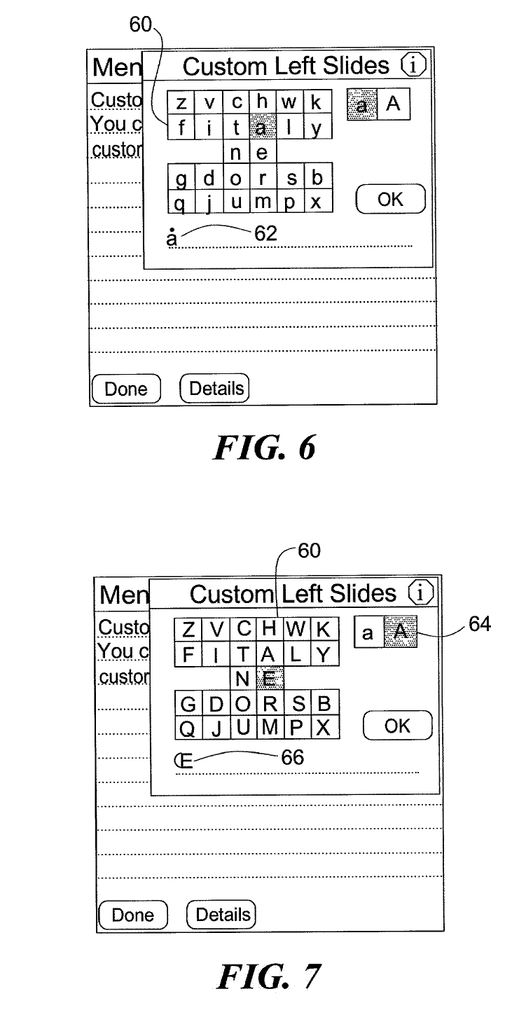

In FIG. 6, the “Fitaly” keyboard 60 of U.S. Pat. No. 5,487,616 is displayed. By sliding to the left after touching the “a” character, the current setting for that action for that character is displayed to the user as shown at 62. By clicking on the “A” box 64, FIG. 7, and then touching “E” and sliding to the left, the “CΕ” extended character is displayed as shown at 66 providing the user with an indication of what happens when this action is taken on the keyboard during text entry.

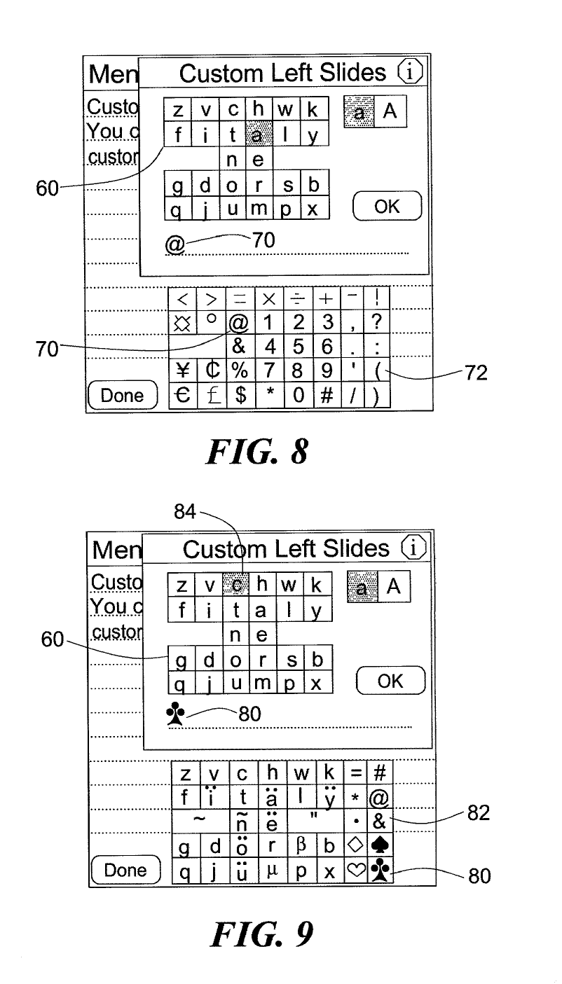

Customization is easily accomplished by touching on the “a” character in FIG. 8 under the custom left slide menu and selecting the @ character 70 from table 72. Thereafter, when the user touches the letter “a” and slides to the left, the @ character will be displayed and entered. In FIG. 9, the user has selected the club suite 80 from character table 82 to correspond to a touch on the letter C as shown at 84 and a slide to the left.

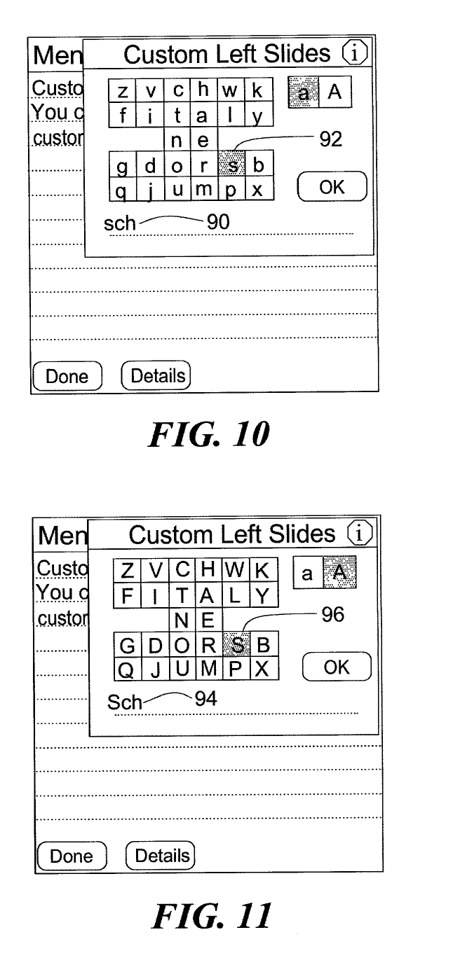

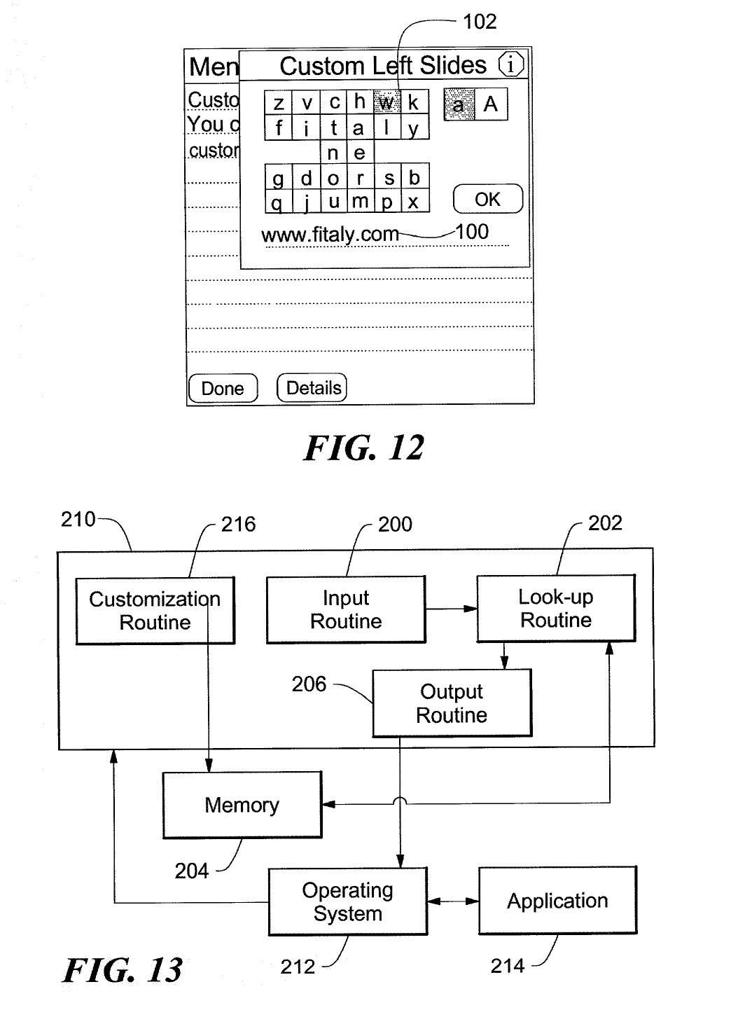

Rather than selecting extended characters from a set of predefined tables, the user can also enter “sch” as shown at 90, FIG. 10 to correspond to a touch on the letter “s” as shown at 92 and a slide to the left. FIG. 11 shows the same result for “Sch” as shown at 94 when the capital letter S is selected as shown at 96. Other sequences of characters or even actions can be selected to correspond to touches on a given character, icon, or button displayed on the touchscreen and a slide in a predetermined direction depending on the user's preferences, nationality, and typical usage. As shown in FIG. 12, a web-site address 100 can be set as the corresponding entry action when a user touches the character “w” as shown at 102 and slides the pen to the left. Other options include touching a character and sliding in a particular direction to denote switching from one application program to another. In addition, icons and even buttons on the touch-screen can be conveniently reconfigured such that a touch on an icon performs the usual action but a touch on the icon and then a slide away from the icon in a particular direction denotes a different preselected action.

Computer program 210, FIG. 13 for entering accented and other extended characters, in accordance with this invention includes input routine 200 which determines which character was touched on the keyboard and the direction of a slide away from the touched character as shown in FIG. 2. Lookup routine 202, FIG. 13 matches the touched character and the direction of the slide with the corresponding extended character stored in memory 204. The default settings initially stored in memory 204 are shown in FIG. 3. Output routine 206, FIG. 13 enters and causes the display of the corresponding extended character. Computer program 200 operates under the control of operating system 212 such as the Palm OS or Windows CE programs which conveniently include output signals representing the coordinates of a touch on a touch-screen. Operating system 212, typically provided with most hand held, lap top, and other electronic devices, then controls application programs 214 such as MemoPad and Pocket Word. Output routine 206 is configured to initially enter the touched character and then replace the entered character with the selected extended character after a slide in particular direction as shown in FIGS. 1-2. Output routine 206, FIG. 13 also changes the touched character to the selected extended character on the keyboard representation as shown in FIG. 2.

In one embodiment, input routine 200, FIG. 13 is further configured to determine the length of each slide. In this way, the stored set of extended characters in memory 204 can correspond to slides of a short length and further included is a stored set of upper case characters corresponding to slides of a longer length in accordance with the prior art Microsoft programming.

Customization routine 216 is configured to display the stored set of extended characters and their corresponding set of slide directions and allows the user to replace a stored extended character with a different character, a sequence of characters, or an action as shown in FIG. 6-12.

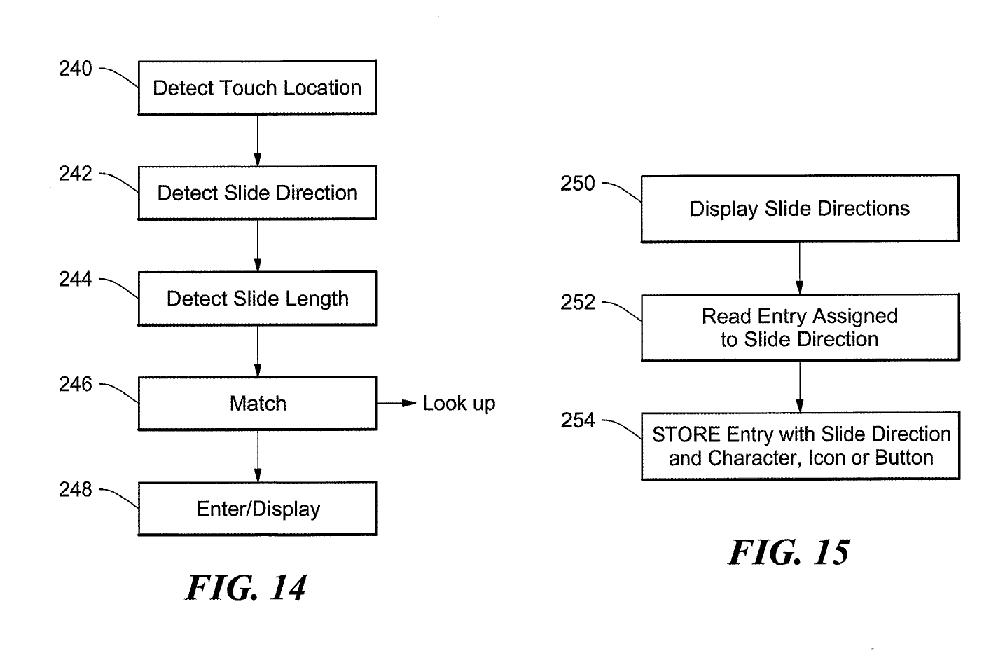

Thus, input routine 200, FIG. 13 determines which character was touched, step 240, FIG. 14, the direction of a slide away from the touched character, step 242, and the slide length, step 244. Lookup routine 202, FIG. 13 matches the touched character and the direction of the slide with the corresponding extended character stored in memory 204, step 246, FIG. 14. Output routine 206, FIG. 13 then enters and causes the display of the corresponding extended character, step 248, FIG. 14.

Customization routine 216, Fig, 13 displays the stored set of extended characters and a corresponding set of slide directions, step 250, FIG. 15 (see FIGS. 4-7) and allows the user to replace a stored extended character with a different character, a sequence of characters, or an action as shown in FIGS. 7-12 by reading the entry assigned by the user to a given slide direction, step 252, FIG. 15 and then storing that entry with the slide direction chosen, step 254.

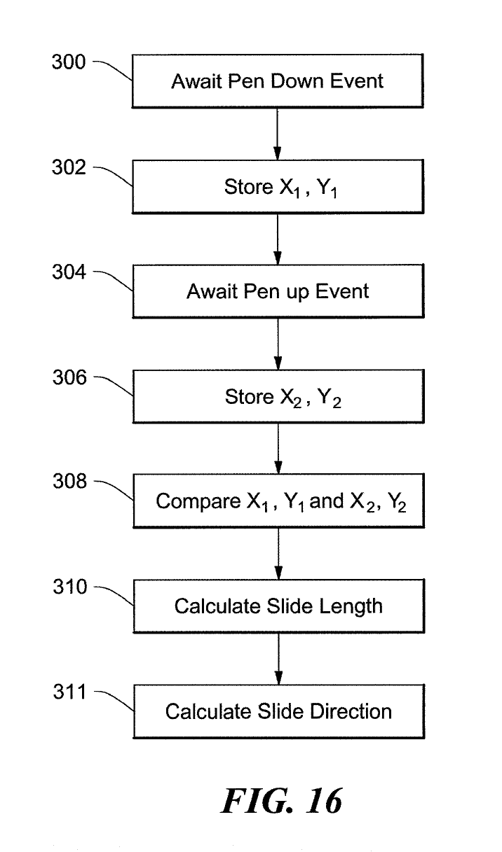

Input routine 200, FIG. 13 which determines which character was touched and the direction of a slide away from the touched character, may be programmed as shown in FIG. 16. First, a pen-down event is detected, step 300. Again, the signals indicative of a pen-down event are provided by operating system 212, FIG. 13. The location information (coordinates x₁ and y₁) is then stored, step 302, FIG. 16 and a pen-up event is detected, step 304. The coordinate information x₂, y₂ where the pen-up event occurred is then stored, step 306. By comparing the relative coordinates, step 308, input routine 200, FIG. 13 is able to calculate the direction and length of a slide, step 310 and 311.

As such, the computer program and method of the subject invention provides a more ergonomic, user friendly, more universal, and customizable way of quickly entering and displaying on a touch-screen a wide variety of characters. By associating different pen slide away from different displayed keyboard characters with a wide variety of extenders not present on the keyboard, the subject invention overcomes the limitations and inconveniences associated with the prior art. Eight or more extended characters per keyboard character can be easily and quickly displayed and entered depending on the user's preferences, nationality, and typical usage.

Tables 1, 2, 3 and 4 below list several examples of the numerous possible extended characters:

TABLE 1

| | ANSI | Unicode | ANSI | Unicode | | |
|---|---|---|---|---|---|---|
| Character | Number | Number | Hex | Hex | Unicode Name | Unicode Range |
| □ | 129 | 129 | 0×81 | U+0081 | (not used) | |
| , | 130 | 8218 | 0×82 | U+201A | Single low-9 quotation | General Punctuation |
| | | | | | mark | |
| ƒ | 131 | 402 | 0×83 | U+0192 | Latin small letter f with | Latin Extended-B |
| | | | | | hook | |
| ,, | 132 | 8222 | 0×84 | U+201E | Double low-9 quotation | General Punctuation |
| | | | | | mark | |
| . . . | 133 | 8230 | 0×85 | U+2026 | Horizontal ellipsis | General Punctuation |
| \ | 134 | 8224 | 0×86 | U+2020 | Dagger | General Punctuation |
| ‡ | 135 | 8225 | 0×87 | U+2021 | Double dagger | General Punctuation |
| \hat{ } | 136 | 710 | 0×88 | U+02C6 | modifier letter circumflex | Spacing Modifier |
| | | | | | accent | Letters |
| ‰ | 137 | 8240 | 0×89 | U+2030 | Per mille sign | General Punctuation |
| \check{S} | 138 | 352 | 0×8A | U+0160 | Latin capital letter S with | Latin Extended-A |
| | | | | | caron | |
| < | 139 | 8249 | 0×8B | U+2039 | Single left-pointing angle | General Punctuation |
| | | | | | quotation mark | |
| [symbol] | 140 | 338 | 0×8C | U+0152 | Latin capital ligature OE | Latin Extended-A |
| □ | 141 | 141 | 0×8D | U+008D | (not used) | |
| \check{Z} | 142 | 381 | 0×8E | U+017D | Latin capital letter Z with | Latin Extended-A |
| | | | | | caron | |
| □ | 143 | 143 | 0×8F | U+008F | (not used) | |
| □ | 144 | 144 | 0×90 | U+0090 | (not used) | |
| ‘ | 145 | 8216 | 0×91 | U+2018 | Left single quotation | General Punctuation |
| | | | | | mark | |
| ’ | 146 | 8217 | 0×92 | U+2019 | Right single quotation | General Punctuation |
| | | | | | mark | |
| “ | 147 | 8220 | 0×93 | U+201C | Left double quotation | General Punctuation |
| | | | | | mark | |
| ” | 148 | 8221 | 0×94 | U+201D | Right double quotation | General Punctuation |
| | | | | | mark | |
| • | 149 | 8226 | 0×95 | U+2022 | Bullet | General Punctuation |
| - | 150 | 8211 | 0×96 | U+2013 | En dash | General Punctuation |
| — | 151 | 8212 | 0×97 | U+2014 | Em dash | General Punctuation |
| ˜ | 152 | 732 | 0×98 | U+02DC | Small tilde | Spacing Modifier |
| | | | | | | Letters |
| ™ | 153 | 8482 | 0×99 | U+2122 | Trade mark sign | Letterlike Symbols |
| \check{s} | 154 | 353 | 0×9A | U+0161 | Latin small letter s with | Latin Extended-A |
| | | | | | caron | |
| > | 155 | 8250 | 0×9B | U+203A | Single right-pointing | General Punctuation |
| | | | | | angle quotation mark | |
| œ | 156 | 339 | 0×9C | U+0153 | Latin small ligature oe | Latin Extended-A |
| □ | 157 | 157 | 0×9D | U+009D | (not used) | |
| \check{z} | 158 | 382 | 0×9E | U+017E | Latin small letter z with | Latin Extended-A |
| | | | | | caron | |
| Ÿ | 159 | 376 | 0×9F | U+0178 | Latin capital letter Y with | Latin Extended-A |
| | | | | | diaeresis | |
| [symbol] | 160 | 160 | 0×A0 | U+00A0 | No-break space | Latin-1 Supplement |
| [symbol] | 161 | 161 | 0×A1 | U+00A1 | Inverted exclamation | Latin-1 Supplement |
| | | | | | mark | |
| ¢ | 162 | 162 | 0×A2 | U+00A2 | Cent sign | Latin-1 Supplement |
| £ | 163 | 163 | 0×A3 | U+00A3 | Pound sign | Latin-1 Supplement |
| ¤ | 164 | 164 | 0×A4 | U+00A4 | Currency sign | Latin-1 Supplement |
| ¥ | 165 | 165 | 0×A5 | U+00A5 | Yen sign | Latin-1 Supplement |
| ¦ | 166 | 166 | 0×A6 | U+00A6 | Broken bar | Latin-1 Supplement |
| § | 167 | 167 | 0×A7 | U+00A7 | Section sign | Latin-1 Supplement |
| \ddot{ } | 168 | 168 | 0×A8 | U+00A8 | Diaeresis | Latin-1 Supplement |
| © | 169 | 169 | 0×A9 | U+00A9 | Copyright sign | Latin-1 Supplement |
| ^{a} | 170 | 170 | 0×AA | U+00AA | Feminine ordinal | Latin-1 Supplement |
| | | | | | indicator | |
| << | 171 | 171 | 0×AB | U+00AB | Left-pointing double | Latin-1 Supplement |
| | | | | | angle quotation mark | |
| [symbol] | 172 | 172 | 0×AC | U+00AC | Not sign | Latin-1 Supplement |
| | 173 | 173 | 0×AD | U+00AD | Soft hyphen | Latin-1 Supplement |
| ® | 174 | 174 | 0×AE | U+00AE | Registered sign | Latin-1 Supplement |
| \overline{ } | 175 | 175 | 0×AF | U+00AF | macron | Latin-1 Supplement |
| ° | 176 | 176 | 0×B0 | U+00B0 | Degree sign | Latin-1 Supplement |
| ± | 177 | 177 | 0×B1 | U+00B1 | Plus-minus sign | Latin-1 Supplement |
| ² | 178 | 178 | 0×B2 | U+00B2 | Superscript two | Latin-1 Supplement |
| ³ | 179 | 179 | 0×B3 | U+00B3 | Superscript three | Latin-1 Supplement |
| \acute{ } | 180 | 180 | 0×B4 | U+00B4 | Acute accent | Latin-1 Supplement |
| μ | 181 | 181 | 0×B5 | U+00B5 | micro sign | Latin-1 Supplement |
| ¶ | 182 | 182 | 0×B6 | U+00B6 | Pilcrow sign | Latin-1 Supplement |
| · | 183 | 183 | 0×B7 | U+00B7 | middle dot | Latin-1 Supplement |
| [symbol] | 184 | 184 | 0×B8 | U+00B8 | Cedilla | Latin-1 Supplement |
| ¹ | 185 | 185 | 0×B9 | U+00B9 | Superscript one | Latin-1 Supplement |
| ^{o} | 186 | 186 | 0×BA | U+00BA | masculine ordinal | Latin-1 Supplement |
| | | | | | indicator | |
| >> | 187 | 187 | 0×BB | U+00BB | Right-pointing double | Latin-1 Supplement |
| | | | | | angle quotation mark | |
| ¼ | 188 | 188 | 0×BC | U+00BC | Vulgar fraction one | Latin-1 Supplement |
| | | | | | quarter | |
| ½ | 189 | 189 | 0×BD | U+00BD | Vulgar fraction one half | Latin-1 Supplement |
| ¾ | 190 | 190 | 0×BE | U+00BE | Vulgar fraction three | Latin-1 Supplement |
| | | | | | quarters | |
| [symbol] | 191 | 191 | 0×BF | U+00BF | Inverted question mark | Latin-1 Supplement |
| À | 192 | 192 | 0×C0 | U+00C0 | Latin capital letter A with | Latin-1 Supplement |
| | | | | | grave | |
| Á | 193 | 193 | 0×C1 | U+00C1 | Latin capital letter A with | Latin-1 Supplement |
| | | | | | acute | |
| Â | 194 | 194 | 0×C2 | U+00C2 | Latin capital letter A with | Latin-1 Supplement |
| | | | | | circumflex | |
| Ã | 195 | 195 | 0×C3 | U+00C3 | Latin capital letter A with | Latin-1 Supplement |
| | | | | | tilde | |
| Ä | 196 | 196 | 0×C4 | U+00C4 | Latin capital letter A with | Latin-1 Supplement |
| | | | | | diaeresis | |
| Å | 197 | 197 | 0×C5 | U+00C5 | Latin capital letter A with | Latin-1 Supplement |
| | | | | | ring above | |
| [symbol] | 198 | 198 | 0×C6 | U+00C6 | Latin capital letter AE | Latin-1 Supplement |
| [symbol] | 199 | 199 | 0×C7 | U+00C7 | Latin capital letter C with | Latin-1 Supplement |
| | | | | | cedilla | |
| È | 200 | 200 | 0×C8 | U+00C8 | Latin capital letter E with | Latin-1 Supplement |
| | | | | | grave | |
| É | 201 | 201 | 0×C9 | U+00C9 | Latin capital letter F with | Latin-1 Supplement |
| | | | | | acute | |
| Ê | 202 | 202 | 0×CA | U+00CA | Latin capital letter E with | Latin-1 Supplement |
| | | | | | circumflex | |
| Ë | 203 | 203 | 0×CB | U+00CB | Latin capital letter E with | Latin-1 Supplement |
| | | | | | diaeresis | |
| Ì | 204 | 204 | 0×CC | U+00CC | Latin capital letter I with | Latin-1 Supplement |
| | | | | | grave | |
| Í | 205 | 205 | 0×CD | U+00CD | Latin capital letter I with | Latin-1 Supplement |
| | | | | | acute | |
| Î | 206 | 206 | 0×CE | U+00CE | Latin capital letter I with | Latin-1 Supplement |
| | | | | | circumflex | |
| Ï | 207 | 207 | 0×CF | U+00CF | Latin capital letter I with | Latin-1 Supplement |
| | | | | | diaeresis | |
| [symbol] | 208 | 208 | 0×D0 | U+00D0 | Latin capital letter Eth | Latin-1 Supplement |
| Ñ | 209 | 209 | 0×D1 | U+00D1 | Latin capital letter N with | Latin-1 Supplement |
| | | | | | tilde | |
| Ò | 210 | 210 | 0×D2 | U+00D2 | Latin capital letter O with | Latin-1 Supplement |
| | | | | | grave | |
| Ó | 211 | 211 | 0×D3 | U+00D3 | Latin capital letter O with | Latin-1 Supplement |
| | | | | | acute | |
| Ô | 212 | 212 | 0×D4 | U+00D4 | Latin capital letter O with | Latin-1 Supplement |
| | | | | | circumflex | |
| Õ | 213 | 213 | 0×D5 | U+00D5 | Latin capital letter O with | Latin-1 Supplement |
| | | | | | tilde | |
| Ö | 214 | 214 | 0×D6 | U+00D6 | Latin capital letter O with | Latin-1 Supplement |
| | | | | | diaeresis | |
| × | 215 | 215 | 0×D7 | U+00D7 | multiplication sign | Latin-1 Supplement |
| Ø | 216 | 216 | 0×D8 | U+00D8 | Latin capital letter O with | Latin-1 Supplement |
| | | | | | stroke | |
| Ù | 217 | 217 | 0×D9 | U+00D9 | Latin capital letter U with | Latin-1 Supplement |
| | | | | | grave | |
| Ú | 218 | 218 | 0×DA | U+00DA | Latin capital letter U with | Latin-1 Supplement |
| | | | | | acute | |
| Û | 219 | 219 | 0×DB | U+00DB | Latin capital letter U with | Latin-1 Supplement |
| | | | | | circumflex | |
| Ü | 220 | 220 | 0×DC | U+00DC | Latin capital letter U with | Latin-1 Supplement |
| | | | | | diaeresis | |
| Ý | 221 | 221 | 0×DD | U+00DD | Latin capital letter Y with | Latin-1 Supplement |
| | | | | | acute | |
| [symbol] | 222 | 222 | 0×DE | U+00DE | Latin capital letter Thorn | Latin-1 Supplement |
| β | 223 | 223 | 0×DF | U+00DF | Latin small letter sharp s | Latin-1 Supplement |
| à | 224 | 224 | 0×E0 | U+00E0 | Latin small letter a with | Latin-1 Supplement |
| | | | | | grave | |
| á | 225 | 225 | 0×E1 | U+00E1 | Latin small letter a with | Latin-1 Supplement |
| | | | | | acute | |
| â | 226 | 226 | 0×E2 | U+00E2 | Latin small letter a with | Latin-1 Supplement |
| | | | | | circumflex | |
| ã | 227 | 227 | 0×E3 | U+00E3 | Latin small letter a with | Latin-1 Supplement |
| | | | | | tilde | |
| ä | 228 | 228 | 0×E4 | U+00E4 | Latin small letter a with | Latin-1 Supplement |
| | | | | | diaeresis | |
| å | 229 | 229 | 0×E5 | U+00E5 | Latin small letter a with | Latin-1 Supplement |
| | | | | | ring above | |
| æ | 230 | 230 | 0×E6 | U+00E6 | Latin small letter ae | Latin-1 Supplement |
| ç | 231 | 231 | 0×E7 | U+00E7 | Latin small letter c with | Latin-1 Supplement |
| | | | | | cedilla | |
| è | 232 | 232 | 0×E8 | U+00E8 | Latin small letter e with | Latin-1 Supplement |
| | | | | | grave | |
| é | 233 | 233 | 0×E9 | U+00E9 | Latin small letter e with | Latin-1 Supplement |
| | | | | | acute | |
| ê | 234 | 234 | 0×EA | U+00EA | Latin small letter e with | Latin-1 Supplement |
| | | | | | circumflex | |
| ë | 235 | 235 | 0×EB | U+00EB | Latin small letter e with | Latin-1 Supplement |
| | | | | | diaeresis | |
| ì | 236 | 236 | 0×EC | U+00EC | Latin small letter i with | Latin-1 Supplement |
| | | | | | grave | |
| í | 237 | 237 | 0×ED | U+00ED | Latin small letter i with | Latin-1 Supplement |
| | | | | | acute | |
| î | 238 | 238 | 0×EE | U+00EE | Latin small letter i with | Latin-1 Supplement |
| | | | | | circumflex | |
| \ddot{ ×} | 239 | 239 | 0×EF | U+00EF | Latin small letter i with | Latin-1 Supplement |
| | | | | | diaeresis | |
| [symbol] | 240 | 240 | 0×F0 | U+00F0 | Latin small letter eth | Latin-1 Supplement |
| ñ | 241 | 241 | 0×F1 | U+00F1 | Latin small letter n with | Latin-1 Supplement |
| | | | | | tilde | |
| ò | 242 | 242 | 0×F2 | U+00F2 | Latin small letter o with | Latin-1 Supplement |
| | | | | | grave | |
| ò | 243 | 243 | 0×F3 | U+00F3 | Latin small letter o with | Latin-1 Supplement |
| | | | | | acute | |
| ô | 244 | 244 | 0×F4 | U+00F4 | Latin small letter o with | Latin-1 Supplement |
| | | | | | circumflex | |
| Õ | 245 | 245 | 0×F5 | U+00F5 | Latin small letter o with | Latin-1 Supplement |
| | | | | | tilde | |
| ö | 246 | 246 | 0×F6 | U+00F6 | Latin small letter o with | Latin-1 Supplement |
| | | | | | diaeresis | |
| ÷ | 247 | 247 | 0×F7 | U+00F7 | Division sign | Latin-1 Supplement |
| ø | 248 | 248 | 0×F8 | U+00F8 | Latin small letter o with | Latin-1 Supplement |
| | | | | | stroke | |
| ù | 249 | 249 | 0×F9 | U+00F9 | Latin small letter u with | Latin-1 Supplement |
| | | | | | grave | |
| ú | 250 | 250 | 0×FA | U+00FA | Latin small letter u with | Latin-1 Supplement |
| | | | | | acute | |
| û | 251 | 251 | 0×FB | U+00FB | Latin small letter with | Latin-1 Supplement |
| | | | | | circumflex | |
| ü | 252 | 252 | 0×FC | U+00FC | Latin small letter u with | Latin-1 Supplement |
| | | | | | diaeresis | |
| ý | 253 | 253 | 0×FD | U+00FD | Latin small letter y with | Latin-1 Supplement |
| | | | | | acute | |
| [symbol] | 254 | 254 | 0×FE | U+00FE | Latin small letter thorn | Latin-1 Supplement |
| y | 255 | 255 | 0×FF | U+00FF | Latin small letter y with | Latin-1 Supplement |
| | | | | | diaeresis | |

TABLE 2
Upper Case Greek Letters

| Letter | Name | Unicode |
|---|---|---|
| A | capital Alpha | &#913; |
| B | capital Beta | &#914; |
| Γ | capital Gamma | &#915; |
| Δ | capital Delta | &#916; |
| Ε | capital Epsilon | &#917; |
| Z | capital Zeta | &#918; |
| H | capital Eta | &#919; |
| Θ | capital Theta | &#920; |
| I | capital Iota | &#921; |
| K | capital Kappa | &#922; |
| Λ | capital Lambda | &#923; |
| M | capital Mu | &#924; |
| N | capital Nu | &#925; |
| Ξ | capital Xi | &#926; |
| O | capital Omicron | &#927; |
| Π | capital Pi | &#928; |
| P | capital Rho | &#929; |
| Σ | capital Sigma | &#931; |
| T | capital Tau | &#932; |
| Υ | capital Upsilon | &#933; |
| Φ | capital Phi | &#934; |
| X | capital Chi | &#935; |
| Ψ | capital Psi | &#936; |
| Ω | capital Omega | &#937; |

TABLE 3
Lower Case Greek Letters

| Letter | Name | Unicode |
|---|---|---|
| α | lower case alpha | &#945; |
| β | lower case beta | &#946; |
| γ | lower case gamma | &#947; |
| δ | lower case delta | &#948; |
| ε | lower case epsilon | &#949; |
| ζ | lower case zeta | &#950; |
| η | lower case eta | &#951; |
| θ | lower case theta | &#952; |
| ι | lower case iota | &#953; |
| κ | lower case kappa | &#954; |
| λ | lower case lambda | &#955; |
| μ | lower case mu | &#956; |
| ν | lower case nu | &#957; |
| ξ | lower case case xi | &#958; |
| ο | lower case omicron | &#959; |
| π | lower case pi | &#960; |
| ρ | lower case rho | &#961; |
| [symbol] | lower case sigma | &#962; |
| σ | lower case sigma | &#963; |
| τ | lower case tau | &#964; |
| υ | lower case upsilon | &#965; |
| φ | lower case phi | &#966; |
| χ | lower case chi | &#967; |
| ψ | lower case psi | &#968; |
| ω | lower case omega | &#969; |

TABLE 4
Table of Extended Symbols

| Letter | Name | Unicode |
|---|---|---|
| Arrows | | |
| ← | arrow left | &#8592; |
| ↑ | arrow up | &#8593; |
| → | arrow right | &#8594; |
| ↓ | arrow down | &#8595; |
| [symbol] | arrow left and right | &#8596; |
| Mathematical Operators | | |
| ∂ | partial differential | &#8706; |
| Π | n-ary product | &#8719; |
| Σ | n-ary summation | &#8721; |
| √ | square root | &#8730; |
| ∞ | infinity | &#8734; |
| ∩ | intersection | &#8745; |
| ∫ | integral | &#8747; |
| ≈ | almost equal to | &#8776; |
| ≠ | not equal to | &#8800; |
| ≡ | identical to | &#8801; |
| Miscellaneous Symbols | | |
| ⋄ | lozenge | &#9674; |
| [symbol] | black spade suit | &#9824; |
| [symbol] | black club suit | &#9827; |
| ♥ | black heart suit | &#9829; |
| ♦ | black diamond suit | &#9830; |

However, as delineated above, customization routine 216, FIG. 13 displays to the user a set of slide direction and allows the user to assign entries representing actions to slide directions for a plurality of extended characters and also even icons or buttons. As such, the subject invention is not limited to the set of extended characters of the Tables above. Input routine 200 then determines a touch location on a touch screen representing a character, icon, or a button and the direction of a slide away from the touched location. Lookup routine 202 matches the touched location and the direction of the slide with the corresponding assigned entry of any type, and output routine 206 then performs the user defined action represented by the corresponding entry.

As such, the method of this invention facilitates entering accented and other extended characters which is easier and less time consuming than prior art methods wherein a pull-down menu must be activated. The method is much more versatile than the prior art Windows CE method of entering capital letters. The method of this invention provides a more ergonomic, user-friendly, and universal way of entering extended characters. The computer program of this invention allows the user to customize a hand-held electronic device to more quickly enter a wide variety of characters, icons, or even buttons and to then more quickly have the electronic device perform the action represented by the corresponding entry. The number of keyboard characters can be multiplied by 8 using the subject invention or even by 16 if slide length is taken into account.

Attached hereto as Appendix 1 is a representative example of the computer programming associated with the best mode of the subject invention.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

[image]

[image]

[image]

[image]

[image]

[image]

[image]

[image]

What is claimed is:

1. A method of entering extended characters, the method comprising:
detecting, on a touch screen, a touch on a character and a slide away from the character;
determining the direction of the slide;
matching the direction of the slide with a stored set of extended characters each associated with a corresponding different slide direction; and
entering the extended character which corresponds to the determined slide direction.

2. The method of claim 1 further including initially entering the touched character and then replacing the touched character with the corresponding extended character after the slide.

3. The method of claim 1 further including modifying an on-screen keyboard to change the touched character to the extended character.

4. The method of claim 1 in which the stored set of extended characters includes accented characters and, for each character, the character marked with a grave, a dot, the umlaut, the acute, and the circumflex, each said accent corresponding to a slide in a different direction.

5. The method of claim 1 further including determining the length of the slide.

6. The method of claim 5 including a first stored set of extended characters corresponding to slides of a first length and a second stored set of extended characters corresponding to slides of a second, different length.

7. The method of claim 6 in which the second length is longer that the first length.

8. The method of claim 7 in which the second stored set of extended characters are upper case versions of the first stored set of extended characters.

9. The method of claim 1 further including the steps of displaying the stored set of extended characters and their corresponding slide directions and allowing the user to replace an extended character with a different character, a sequence of characters, or an action.

10. The method of claim 1 in which there are at least five slide directions, each said slide direction corresponding to a different extended character.

11. A method of entering extended characters, the method comprising:
detecting, on a touch screen, a touch on a character and a slide away from the character;
determining the direction of the slide;
matching the direction of the slide with a stored set of extended characters each associated with a corresponding different slide direction;
entering the extended character which corresponds to the determined slide direction; and
displaying a stored set of extended characters and their corresponding slide directions and allowing the user to replace a stored extended character with a different character, a sequence of characters, or an action.

12. A method of entering accented characters, the method comprising:
detecting on a touch screen a touch on a character and a slide away from the character;
determining the direction of the slide;
matching the direction of the slide with a stored set of accented characters each associated with one of at least five different slide directions; and
entering the accented character which corresponds to the determined slide direction.

13. A computer program for entering extended characters, the program comprising:
a stored set of extended characters each corresponding to a different slide direction;
an input routine which determines which character was touched and the direction of a slide away from the touched character;
a lookup routine which matches the touched character and the direction of the slide with the corresponding stored extended character; and
an output routine which enters the corresponding stored extended character.

14. The computer program of claim 13 in which the output routine initially enters and displays the touched character and then replaces the touched character with the extended character after the slide.

15. The computer program of claim 13 in which the output routine modifies an on-screen keyboard to change the touched character to the extended character.

16. The computer program of claim 13 in which the stored set of extended characters includes accented characters and, for each character, the character marked with the grave, the dot, the umlaut, the acute, and the circumflex, each said accent corresponding to a slide in a different direction.

17. The computer program of claim 13 in which the input routine is further configured to determine the length of the slide.

18. The computer program of claim 17 in which the stored set of extended characters includes a first set corresponding to slides of a first length and a second set corresponding to slides of a second, different length.

19. The computer program of claim 18 in which the second set of extended characters are upper case versions of the first stored set of extended characters.

20. The computer program of claim 13 further including a customization routine which displays the stored set of extended characters and their corresponding set of slide directions and allows the user to replace a stored extended character with a different character, a sequence of characters, or an action.

21. The computer program of claim 13 in which there are at least five slide directions, each said direction corresponding to a different extended character.

22. A computer program for entering extended characters, the program comprising:
a stored set of extended characters each corresponding to a different slide direction;
an input routine which determines which character was touched and the direction of a slide away from the touched character;
a lookup routine which matches the touched character and the direction of the slide with a corresponding stored extended character;
an output routine which enters the corresponding extended character; and
a customization routine which displays the stored set of extended characters and the corresponding set of slide directions and which allows the user to replace a stored extended character with a different character, a sequence of characters, or an action.

23. A computer program for entering accented characters, the program comprising:
a stored set of accented characters each corresponding to one of at least five different slide directions;
an input routine which determines which character was touched and the direction of a slide away from the touched character;
a lookup routine which matches the touched character and the direction of the slide with the corresponding stored accented character; and
an output routine which enters of the corresponding accented character.

24. A method of customizing input for an electronic device with a touch screen, the method comprising:
displaying, on a touch screen, a set of slide directions and allowing the user to assign an entry to a slide direction representing an action for a plurality of characters, icons, or buttons;
storing each entry with its corresponding slide direction and the assigned character, icon, or button;
detecting, on the touch screen, a touch at a location representing a character, icon, or button and a slide away from the touched location;
determining the direction of the slide;
matching the location and the direction of the slide with the corresponding entry; and
performing the action represented by the corresponding entry.

25. The method of claim 24 further including providing a set of default entries including a set of accented characters assigned to each character and each corresponding to a different slide direction.

26. The method of claim 24 further including the step of displaying a touched character and replacing the touched character with the action performed.

27. The method of claim 24 further including determining the length of the slide .

28. The method of claim 27 in which the assigned entries correspond to slides of different lengths.

29. The method of claim 27 in which there are at least five slide directions each said direction corresponding to a different entry.

30. A system for customizing input for an electronic device with a touch screen, the system comprising:
a customization routine which displays to a user a set of slide directions and allows the user to assign entries representing actions to a slide direction for a plurality of characters, icons, or buttons;
an input routine which determines a touch location on the touch screen representing a character, icon, or button and the direction of a slide away from the touch location;
a lookup routine which matches the touch location and the direction of the slide with the corresponding assigned entry; and
an output routine which performs the action represented by the corresponding entry.
